(19) United States
(12) Patent Application Publication
(10) Pub. No.: US 2021/0300676 A1
(43) Pub. Date: Sep. 30, 2021

(54) GARBAGE BAG

(71) Applicant: Changsha Suixin Automation Technology Co., Ltd., Changsha City (CN)

(72) Inventors: Zhigan Wang, Changsha City (CN); Hongyu Li, Changsha City (CN); Bin Cai, Changsha City (CN); Wei Shu, Changsha City (CN)

(21) Appl. No.: 17/138,184

(22) Filed: Dec. 30, 2020

(30) Foreign Application Priority Data
Jan. 4, 2020 (CN) 202020014048.9

(51) Int. Cl. B65F 1/00; B65D 33/06

(52) U.S. Cl. CPC B65F 1/0006; B65D 33/065

(57) ABSTRACT

The present disclosure relates to other garbage and kitchen garbage classification throwing technologies in the technical field of garbage classification, in particular to a garbage bag. The garbage bag comprises a bag body, wherein the bag body is of a hollow structure with an opening in the top, a pouring opening is formed in the bottom of the bag body, and the bag body is formed in a folding mode so that the bottom of the bag body is fixed to one side of the bag body. When garbage in the bag body needs to be poured out, a point-breaking line or glue is torn off, the bottom of the bag body is separated from one side of the bag body, and after the bottom of the bag body naturally droops, the garbage is poured downwards from the point-breaking line under the gravity of the garbage to be separated from the bag body. Therefore, the garbage in the garbage bag body can be completely poured out without opening bound handles or turning over the garbage bag body or puncturing the garbage bag with a tool, the action is simple and convenient, safety and reliability are achieved, and garbage throwing workers are prevented from being stained.

### TECHNICAL FIELD

The present disclosure relates to other garbage and kitchen garbage classification throwing technologies in the technical field of garbage classification, in particular to a garbage bag.

### BACKGROUND

At present, our country is vigorously popularizing garbage classification, and the specific practice comprises the steps that household garbage is classified according to categories, and garbage bags of the same category are bagged and then thrown into garbage bags. However, based on the structural defects of existing garbage bags, when garbage needs to be recycled, garbage throwing workers need to open bound handle parts or tear the top and then pour out the garbage, so that the garbage is difficult to pour out completely, and if liquid exists in the garbage bag, hands or clothes of the garbage throwing workers are easily stained.

### SUMMARY

Aiming at the problems in the prior art, the present disclosure provides a garbage bag, and garbage in the garbage bag can be poured out without opening bound handle parts.

To solve the technical problems, the following technical solutions are used in the present disclosure:

The garbage bag provided by the present disclosure comprises a bag body, the bag body is of a hollow structure with an opening in the top, and a pouring opening for pouring out garbage is formed in the bottom of the bag body;

when in use, the bag body is folded so that the bottom of the bag body is fixed to one side of the bag body; and when the garbage in the bag body needs to be poured out, the pouring opening is opened, the bottom of the bag body is separated from one side of the bag body, and the garbage is separated from the bag body from the pouring opening after the bottom of the bag body naturally droops.

Further, the bag body comprises a body part and a contraction part arranged at the bottom of the body part, the body part communicates with the contraction part, and the pouring opening is formed in the contraction part.

Further, when the bag body is folded, the bag body is folded along a connecting line of the body part and the contraction part, and then the contraction part is fixed to one side of the body part.

Further, the width of the contraction part is gradually reduced from one end connected to the body part to the other end, an extension part is arranged at the other end of the contraction part, and the pouring opening is formed in the extension part.

Preferably, the extension part is provided with a connecting part, and the connecting part is located between the bottom of the extension part and the pouring opening.

Further, the bottom of the bag body and one side of the bag body are fixed in a welding or buckling or winding or gluing mode.

Further, handle parts are arranged on the two sides of the top of the bag body respectively.

Further, the bag body and the two handle parts are integrally formed.

Further, the pouring opening is sealed in an openable mode.

The garbage bag has the beneficial effects that the pouring opening is formed in the bottom of the bag body, and after the bag body is folded in half, the bottom of the bag body is fixedly connected with one side of the bag body; when the garbage in the bag body needs to be poured out, only the bottom of the bag body needs to be separated from one side of the bag body, the pouring opening is pulled open so that an opening is formed in the bottom of the bag body, and under the gravity effect of the garbage in the bag body, the bottom of the bag body can fall off and the garbage can be separated from the bag body from the opening in the bottom; and therefore, the effect of pouring out the garbage can be achieved without opening the bound handle parts, and the garbage is prevented from staying in the bag body or polluting the surroundings due to liquid in the bag body.

### BRIEF DESCRIPTION OF THE DRAWINGS

FIG. 1 is a schematic diagram of the present disclosure; and

FIG. 2 is a schematic diagram of the present disclosure in a folding state.

Reference signs: 1, bag body; 2, handle part; 3, pouring opening; 4, body part; 5, contraction part; 6, extension part; and 7, connecting part.

### DETAILED DESCRIPTION

In order to facilitate understanding of those skilled in the art, the present disclosure is further described below in combination with an embodiment and accompanying diagrams, and the content mentioned in the embodiment is not limited by the present disclosure. The following describes the present disclosure in detail with reference to the accompanying drawings.

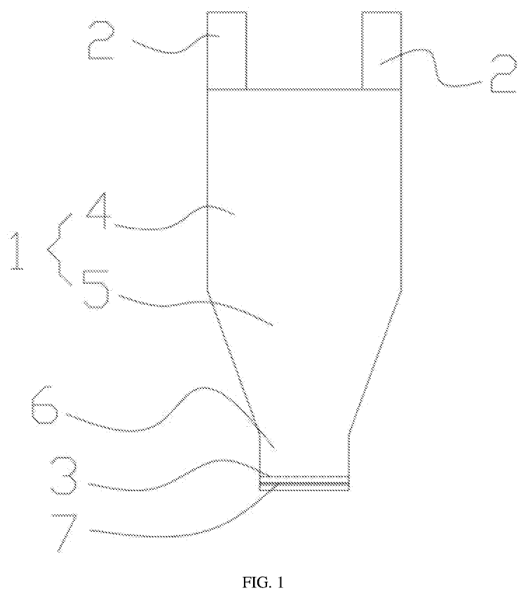

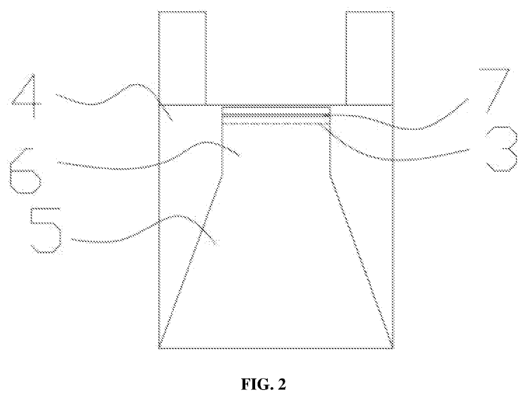

As shown in FIG. 1 and FIG. 2, a garbage bag provided by the present disclosure comprises a bag body 1, the bag body 1 is of a hollow structure with an opening in the top, and a pouring opening 3 for pouring out garbage is formed in the bottom of the bag body 1. Specifically, when the garbage bag is used, the bag body 1 is generally provided with handle parts 2, but the bag body 1 also can be not provided with the handle parts 2, namely, the opening in the top of the bag body 1 is sealed through hot melting or other modes after garbage is bagged.

When the garbage bag is used, the bag body 1 is folded so that the bottom of the bag body 1 is fixed to one side of the bag body 1, and then the garbage can be put into the bag body 1; after the garbage is bagged, the opening in the top can be sealed by binding the two handle parts 2 together or in other modes. When the garbage in the bag body 1 needs to be poured out, the pouring opening 3 is opened, the bottom of the bag body 1 is separated from one side of the bag body 1, the garbage is separated from the bag body 1 from the pouring opening 3 after the bottom of the bag body 1 naturally droops, the garbage can fall off under the action of gravity, and therefore the convenience of pouring out the garbage in the bag body 1 is improved.

Specifically, the pouring opening 3 is preferably formed in the side edge, close to the bottom, of the bag body 1, and therefore garbage throwing workers can conveniently open the pouring opening 3; and meanwhile, the bottom of the bag body 1 is connected to the position, close to the handle parts 2, of the bag body 1 after being folded.

In the embodiment, the bag body 1 comprises a body part 4 and a contraction part 5 arranged at the bottom of the body part 4, the body part 4 communicates with the contraction part 5, the body part 4 is of a structure with an opening in the top end, and the pouring opening 3 is formed in the contraction part 5; and when the bag body 1 is folded, the bag body 1 is folded along a connecting line of the body part 4 and the contraction part 5, and then the contraction part 5 is fixed to one side of the body part 4. Specifically, the width of the contraction part 5 is gradually reduced from one end connected to the body part 4 to the other end, an extension part 6 is arranged at the other end of the contraction part 5, and the pouring opening 3 is formed in the extension part 6. Through the arrangement that the width of the contraction part 5 is shrunk, when the pouring opening 3 is torn off to pour out the garbage, the garbage is limited and prevented from scattering all around.

Preferably, the extension part further comprises a connecting part 7, and the connecting part 7 is arranged between the bottom of the extension part 6 and the pouring opening 3. The connecting part 7 is used for being connected with one side of the bag body 1, and the connecting mode comprises one of welding, buckling, winding, gluing and the like, and is used for enabling garbage throwing workers to rapidly make the bag body 1 separated from a folded state.

In the embodiment, the bag body 1 and the two handle parts 2 are integrally formed.

In the embodiment, the bottom where the pouring opening 3 is located is directly fixed to one side of the bag body 1 at the beginning, and therefore the garbage can be prevented from leaking out in an unsealed mode. However, in order to guarantee the safety of the pouring opening 3, sealing is generally achieved, and the pouring opening 3 is sealed in an openable mode. Specifically, the openable mode comprises the mode that the pouring opening 3 is sealed in a point-breaking line mode or a bonding mode or the like, namely, when garbage throwing workers need to pour the garbage, the pouring opening 3 only needs to be torn off, and then the garbage bag can be easily opened. It needs to be noted that the openable mode referred to in the embodiment is an example only and should not be considered as once openable definition.

In sum, only the better embodiment of the present disclosure is provided, and no limitation is made on the present disclosure in any form, although the better embodiment of the present disclosure is disclosed above, the better embodiment of the present disclosure is not used for limiting the present disclosure and any technician familiar with the specialty without departing from the scope of the technical solutions of the present disclosure; and when the technical content disclosed by the present disclosure is utilized to make some changes or modifications into equivalent embodiments with equivalent changes, but no matter how far away from the technical solutions content of the present disclosure, any simple modification, equivalent changes and modifications made on the embodiments according to the technology of the present disclosure belong to the scope of the technical solutions of the present disclosure.

What is claimed is:

1. A garbage bag, comprising a bag body, the bag body being of a hollow structure with an opening in the top, wherein a pouring opening for pouring out garbage is formed in the bottom of the bag body, and the bottom of the bag body and one side of the bag body are fixed in a welding or buckling or winding or gluing mode.

2. The garbage bag according to claim 1, wherein the bag body comprises a body part and a contraction part arranged at the bottom of the body part, the body part communicates with the contraction part, and the pouring opening is formed in the contraction part.

3. The garbage bag according to claim 2, wherein a connecting line is arranged at the joint of the body part and the contraction part.

4. The garbage bag according to claim 2, wherein the width of the contraction part is gradually reduced from one end connected to the body part to the other end, an extension part is arranged at the other end of the contraction part, and the pouring opening is formed in the extension part.

5. The garbage bag according to claim 4, wherein the extension part is provided with a connecting part, and the connecting part is located between the bottom of the extension part and the pouring opening.

6. The garbage bag according to claim 1, wherein handle parts are arranged on the two sides of the top of the bag body respectively.

7. The garbage bag according to claim 6, wherein the bag body and the two handle parts are integrally formed.

8. The garbage bag according to claim 1, wherein the pouring opening is sealed in an openable mode.
